(19) United States
(12) Patent Application Publication
(10) Pub. No.: US 2009/0026319 A1
(43) Pub. Date: Jan. 29, 2009

(54) Aerial delivery system

(76) Inventor: Edward Strong, Orlando, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/222,485

(22) Filed: Aug. 11, 2008

Related U.S. Application Data
(63) Continuation-in-part of application No. 11/493,944, filed on May 25, 2006, now abandoned.
Application No. 11/493,944 is a continuation of application No. 10/709,186, filed on Apr. 20, 2004, now Pat. No. 7,059,570.

(51) Int. Cl. B64D 17/00

(52) U.S. Cl. 244/152

(57) ABSTRACT

An aerial delivery system including a ram-air parachute, one or more recovery parachutes, a mantle removably attached to a cargo, and a controller operably connected to the mantle, the ram-air parachute, and the one or more recovery parachutes. The controller may be configured to receive location information associated with a target, receive information related to an ambient condition, determine a recovery parachute opening point based on the target information and the ambient condition, and cause a navigation of the aerial delivery system to the determined recovery parachute opening point.

This application is a continuation-in-part of U.S. patent application Ser. No. 11/493,944, filed May 25, 2006, which is a continuation of application of U.S. patent application Ser. No. 10/709,186, filed Apr. 20, 2004, now U.S. Pat. No. 7,059,570, issued Jun. 13, 2006, and entitled “Aerial Delivery Device.” The subject matter of U.S. patent application Ser. No. 11/493,944 and U.S. Pat. No. 7,059,570 is hereby incorporated by reference.

### TECHNICAL FIELD

The present disclosure relates generally to aerial delivery systems and more specifically to guided aerial delivery systems, which may be used to deliver payload and supplies to an intended target.

### BACKGROUND INFORMATION

Aerial delivery systems are often used in the military to deliver vital equipment and supplies from planes flying at varying altitudes to specific ground targets. Typically a plane will fly overhead of the intended ground target, and the supplies or equipment will be dropped from the plane at a calculated air release point (CARP), which is calculated based on various factors such as wind and a parachute drift profile. After being dropped from the aircraft, the attached parachute may open to ensure a soft landing of the supplies and equipment. The supplies, once deployed, are subject to drift due to wind and may also encounter enemy fire causing failure of delivery.

Accuracy and success of delivery can sometimes be increased by taking into consideration the effects of airplane and wind velocity vectors, but changes in wind direction often cause deliveries to drift off into unintended areas and enemy hands. To further increase the accuracy of aerial deliveries, airplanes may fly at lower altitudes so that the potential for drift is reduced; however, this may increase the risk of exposure to enemy anti-aircraft fire.

Further, based on a particular application, weight associated with a cargo payload may vary from under 50 pounds to over 12,000 pounds. Aerially delivering such cargo involves additional considerations, such as sizing one or more parachute canopies and designing cargo support. In addition, it may be desirable to modify navigation patterns based on the weight of the cargo, and to reduce the dependence on a single CARP, among other things.

The present disclosure is directed to mitigating overcoming one or more of the limitations in the art.

### SUMMARY OF DISCLOSURE

In some embodiments, the present disclosure may be directed to an aerial delivery system. The aerial delivery system may include a ram-air parachute, one or more recovery parachutes, a mantle removably attached to a cargo, and a controller operably connected to the mantle, the ram-air parachute, and the one or more recovery parachutes. The controller may be configured to receive location information associated with a target, receive information related to an ambient condition, determine a recovery parachute opening point based on the target information and the ambient condition, and cause a navigation of the aerial delivery system to the determined recovery parachute opening point.

In some other embodiments, the present disclosure may be directed to a method for aerially delivering a cargo system from an aircraft at an altitude. The method may include the steps of receiving location information associated with a target location, receiving condition information related to an ambient condition, determining a recovery parachute opening location based on the condition information and the location information, and deploying a navigable ram-air parachute operably connected to the cargo system. The method may further include the steps of navigating the cargo system to the recovery parachute opening location via the ram-air parachute and one or more steering lines associated with the ram-air parachute, and deploying one or more recovery parachutes at the recovery parachute opening location.

In other embodiments, the present disclosure may be directed to an aerial delivery system. The aerial delivery system may include a ram-air parachute, one or more recovery parachutes, a mantle removably attached to a cargo, and a release bridle having a first end, a second end, and a third end, the second end fixedly attached to a first one of the one or more recovery parachutes, and the third end releasably attached to a second one of the one or more recovery parachutes. The aerial delivery system may further include a drogue parachute affixed to the first end of the release bridle, a pilot parachute operably connected to the drogue parachute, and a controller operably connected to the mantle, the ram-air parachute, and the one or more recovery parachutes. The controller may be configured to receive location information associated with a target, receive information related to an ambient condition, determine a recovery parachute opening point based on the target information and the ambient condition, and cause a navigation of the aerial delivery system to the determined recovery parachute opening point.

The instant disclosure will now be described with particular reference to the accompanying drawings.

### BRIEF DESCRIPTION OF DRAWINGS

FIG. 1 is a perspective view of an exemplary aerial delivery system with the ram-air canopy inflated;

FIG. 2 is an exploded perspective view of the control box and a suspension plate;

FIG. 3 is a block diagram of a guidance control system in accordance with the present disclosure;

FIG. 4A is a perspective view of an alternative embodiment of the control box having the cover removed;

FIG. 4B is a perspective view of another alternative embodiment of the control box having the cover removed;

FIG. 5 is a perspective view of an alternative embodiment of the disclosure illustrating descent under the inflated recovery parachute;

FIG. 6 is a side view of an embodiment of deployment bag;

FIG. 7 is a front view of an embodiment of deployment bag;

FIG. 8 is a perspective view of the control box and ram-air parachute in an alternative embodiment of the disclosure during deployment of the ram-air parachute;

FIG. 9 is a front view of the control box and ram-air parachute in an alternative embodiment of the disclosure during deployment of the ram-air parachute;

FIG. 10A is a perspective view of the control box of an embodiment of the disclosure;

FIG. 10B is a rear view of the control box of the embodiment shown in FIG. 1A;

FIG. 11 is a side view of a polygonal link of the embodiment shown in FIG. 10A;

FIG. 12 is a front view of a recovery parachute activation system of an alternative embodiment of the disclosure;

FIG. 13 is a side view of the recovery parachute activation system shown in FIG. 12;

FIG. 14 is a perspective view of a recovery parachute activation system and payload;

FIG. 15 is a perspective view of an embodiment of the disclosure during deployment of a recovery parachute;

FIG. 16 is a depiction of another exemplary aerial delivery system consistent with the present disclosure;

FIG. 17A is a depiction of an exemplary large load aerial delivery system consistent with the present disclosure;

FIG. 17B is an alternative embodiment of an exemplary large load aerial delivery system consistent with the present disclosure;

FIG. 18 is a depiction of an exemplary mantle configured to support a ram-air parachute, one or more recovery parachutes, and a cargo;

FIG. 19 is a depiction of an exemplary release bridle for embodiments of aerial delivery system using more than one recovery parachute;

FIG. 20 is a depiction of an exemplary rigging for a release bridle;

FIG. 21 is a block diagram showing an exemplary method for aerially delivering a cargo system from an aircraft at altitude;

FIG. 22 is a block diagram of an exemplary deployment sequence for two or more recovery parachutes;

FIG. 23 schematically depicts an exemplary drop zone, determined based on various ambient and aircraft conditions present at a drop time; and

FIG. 24 depicts an exemplary release of two or more recovery parachutes through use of a pilot and drogue parachute, and a release bridle.

### DETAILED DESCRIPTION

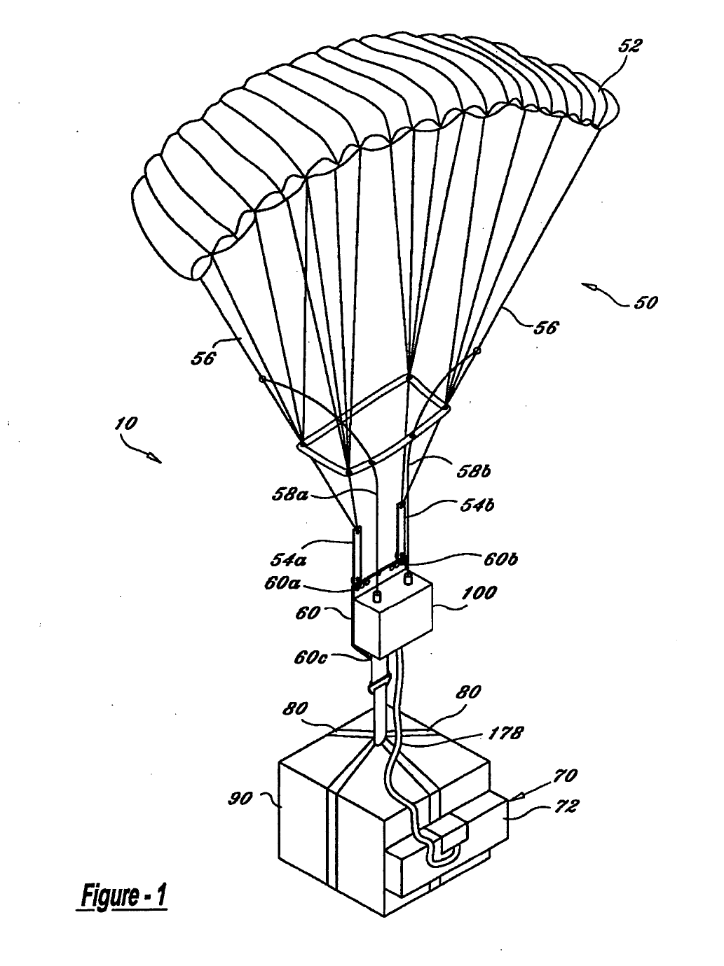

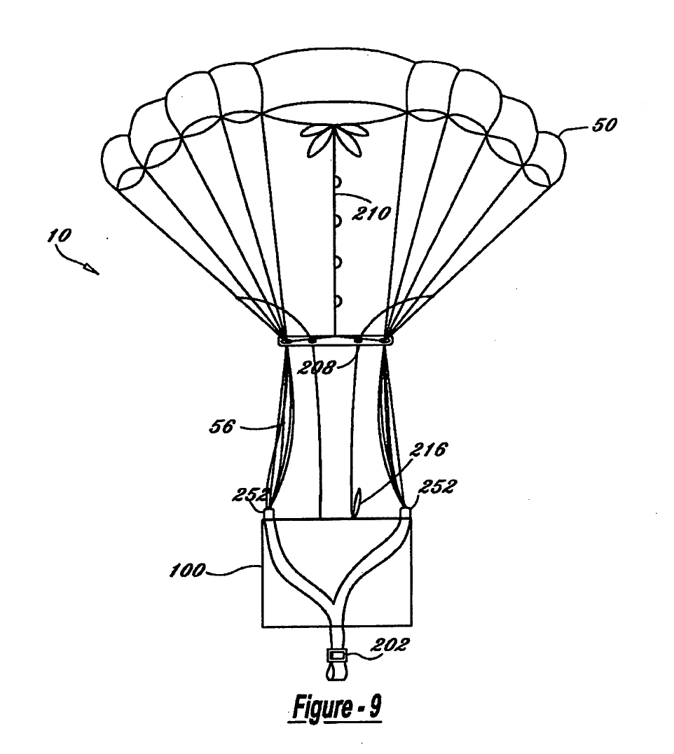

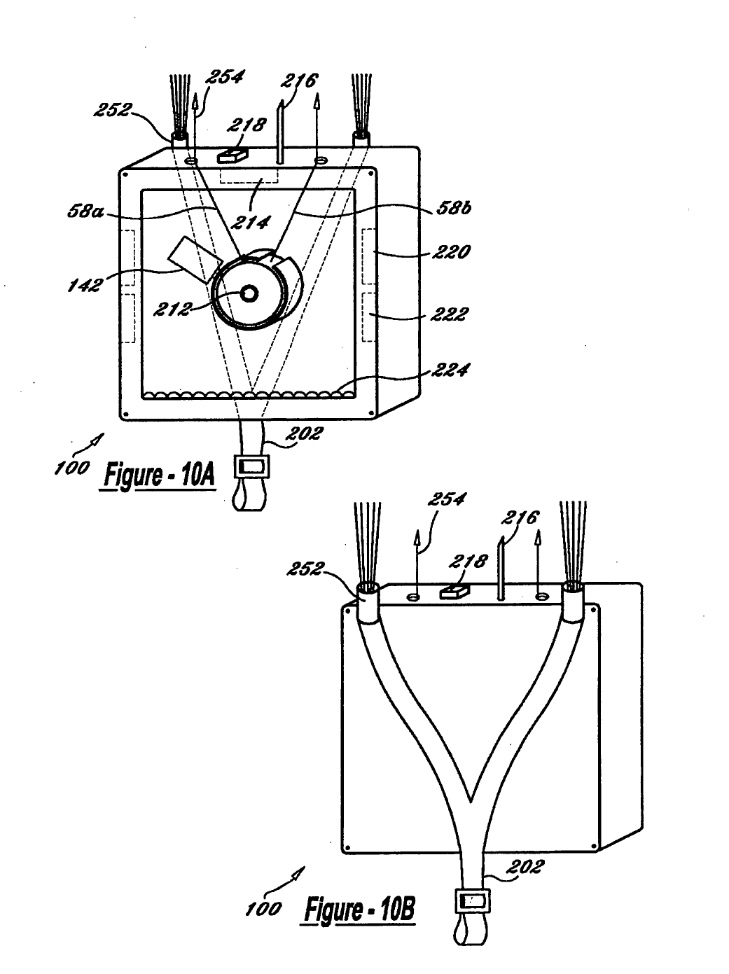

Referring now to FIG. 1, there is seen aerial delivery system 10 with an exemplary ram-air parachute 50 fully inflated. For example, aerial delivery system 10 may comprise a ram-air parachute 50, a control box 100, at least one recovery parachute 70, payload 90, and/or one or more means for retaining/securing the payload 90, such as payload support straps 80. A means for controlling descent orientation, such as suspension plate 60, may be attached between ram-air parachute 50 and the payload 90. As shown, the suspension plate 60 may be attached to, or part of, a control box 100. However, it may be preferred for the control box 100 to serve as the means for controlling descent without reliance upon the suspension plate 60, by means such as, for example, those shown below in FIGS. 9 and 10.

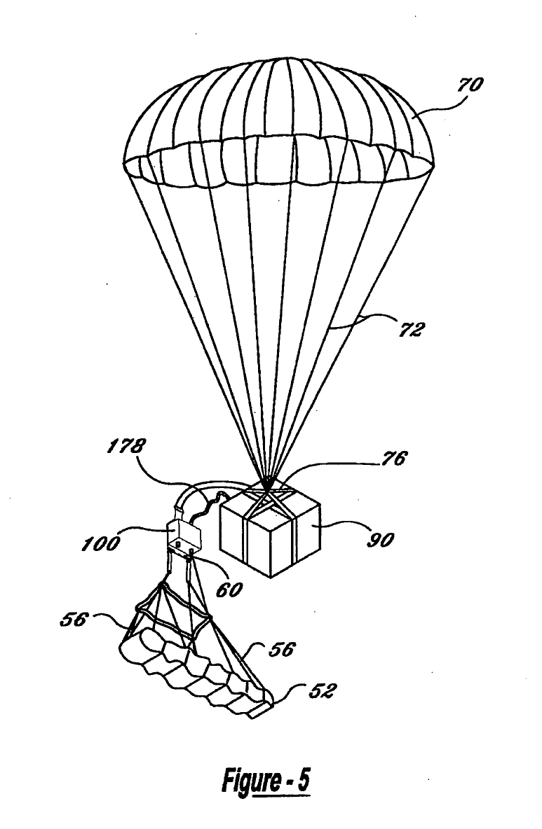

Payload 90 can be safely secured to the bottom of suspension plate 60 at payload suspension point 60c by one or more payload support straps 80. Payload 90 can be attached at a single point or multiple points to suspension plate 60 so that unbalanced payloads do not reduce the maneuverability or usefulness of ram-air parachute 50. Prior to drop-off, recovery parachute 70 may be contained within a recovery parachute container 72. As shown in FIG. 5, recovery parachute 70 may be attached to the payload 90 by parachute riser straps 76, which are connected at the opposite end to suspension lines 72 of recovery parachute 70. Alternatively, recovery parachute 70 may be attached to means for controlling descent orientation, such as the control box 100 or the suspension plate 60.

As shown in FIG. 1, exemplary ram-air parachute 50 may include ram-air canopy 52, one or more riser straps 54a and 54b, one or more suspension lines 56, and one or more steering lines 58a and 58b. Riser straps 54a and 54b can be attached at attachment points 60a and 60b. Several optional adjacent points may be provided at a location, such as the suspension plate 60, so that the distance between attachment points 60a and 60b may be selected for optimizing performance.

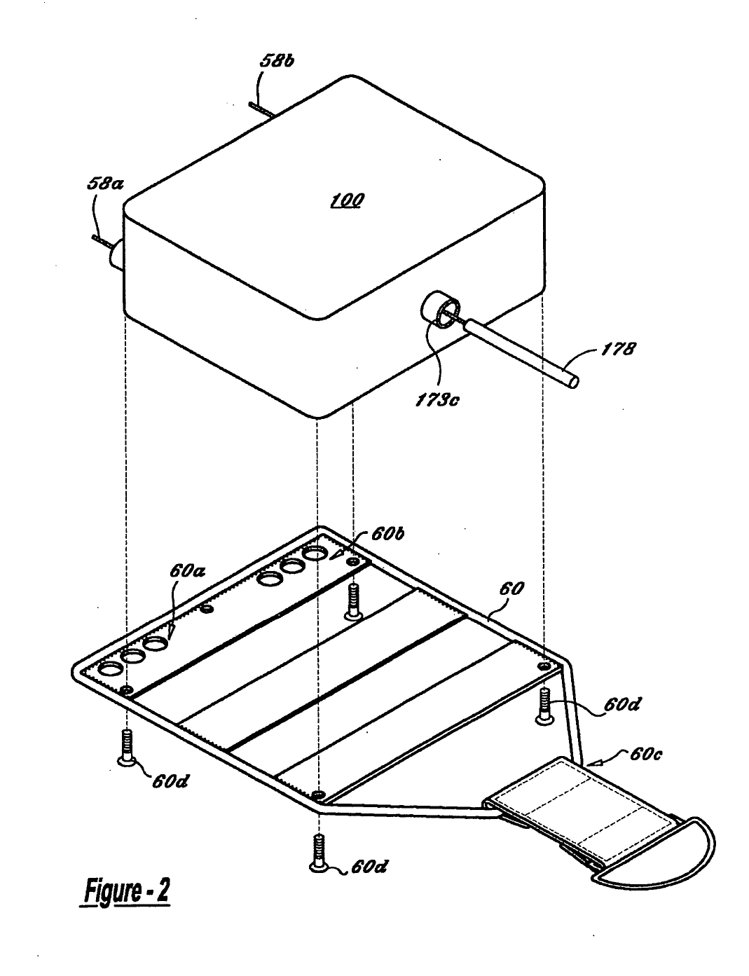

An exemplary suspension plate is shown in FIG. 2. At least a portion of the suspension plate 60 can be triangularly shaped so that corners of the triangle are formed by attachment points 60a and 60b on one side of the plate 60, and payload suspension point 60c may be on the other side of the plate 60. Although a substantially square shape is shown, equivalent shapes are also contemplated. Also, the attachment points 60a, 60b, and the payload suspension point 60c may be attached to the control box 100 itself. Although not shown in this figure, a swivel may be attached between the payload suspension point 60c and the payload 90. By placing attachment points 60a and 60b apart and payload suspension point 60c generally beneath attachment points 60a and 60b, the potential for twisting and tangling riser straps 54a and 54b and/or suspension lines 56 during expansion of the ram-air parachute 50 may be reduced.

Ram-air parachute 50 may be a relatively small, highly maneuverable/steerable ram-air gliding-type canopy, for example, similar to those already in existence, but may be relatively smaller in size than is conventionally used for a particular weight (i.e., overloaded), allowing for the ability to have a higher velocity of descent and forward velocity. Also, the ram-air parachute 50 may be more responsive to steering input via steering lines 58a and 58b and may achieve a much higher controlled velocity of descent and forward speed. The specific canopy size of ram-air parachute 50 may be application- and performance-specific—a higher velocity of descent can be achieved by reducing the size of the canopy, which results in reduced time in the air and therefore reduced time to steer and maneuver the payload to the target. The following are examples of possible ram-air parachute canopy sizes for use with intended cargo weights. However, such should be not considered limiting:

Canopy Size Weight of Cargo

about 50 square feet/about 300 lbs to about 800 lbs

about 100 square feet/about 500 lbs to about 1,000 lbs

about 200 square feet/about 1,000 lbs to about 4,000 lbs

about 500 square feet/about 2,000 lbs to about 10,000 lbs

about 1,000 square feet/about 5,000 lbs to about 12,000 lbs

Aerial delivery system 10 can be carried in-flight by an aircraft. When it is desired to drop the device, doors of the aircraft may be opened and aerial delivery system 10 may be pushed or pulled out of exit doors or dropped from a bay under the aircraft. The aircraft may be provided with alignment tracks, which can be coated with a substance, such as TEFLON, so that the force needed to push aerial delivery system 10 out of the doors is not excessive. Alignment tracks may guide aerial delivery system 10 straight out of the aircraft. A static lanyard (not shown) can be attached at one end to the aircraft and at the other end to ram-air parachute 50. Prior to deployment, ram-air parachute 50 can be housed within a container (not shown).

As aerial delivery system 10 leaves the aircraft, the ram-air parachute 50 may be deployed by means known in the art, such as a static line lanyard. Alternatively, a round drogue may first deploy from the aircraft and then deploy the ram-air parachute 50. On deployment, the round drogue may collapse and stay attached at the top of the ram-air parachute 50. Ram-air parachute 50 reduces the terminal velocity of aerial delivery system 10 and stabilizes attached payload 90 during ram-air freefall, as seen in FIG. 1. Alternatively, as described below, on ram-air parachute deployment, a brake-cord reefing line stages slider deployment by sequencing brake-cord ties on the reefing line.

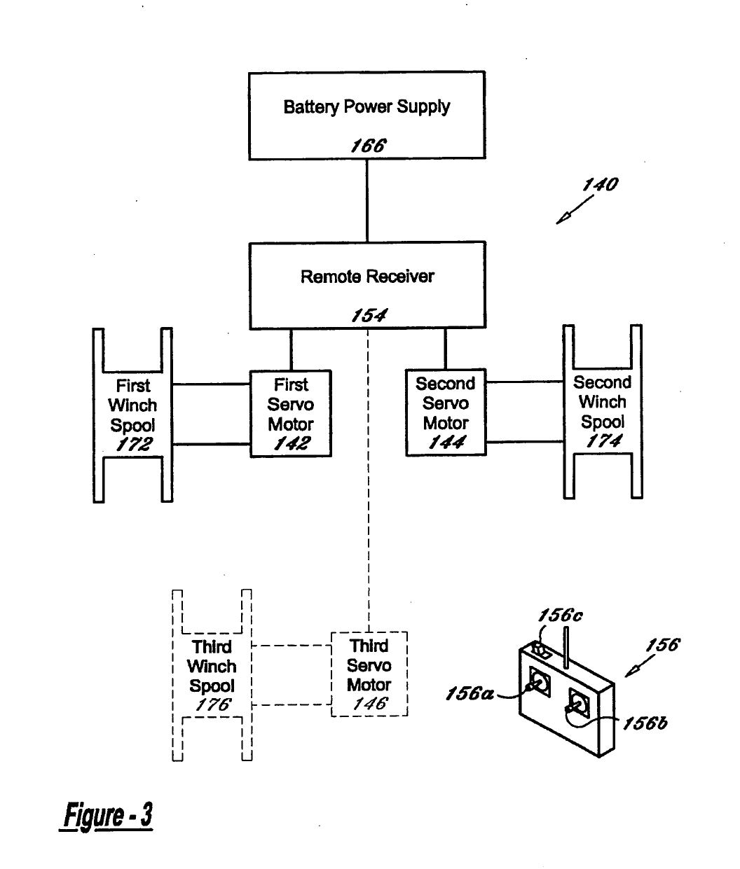

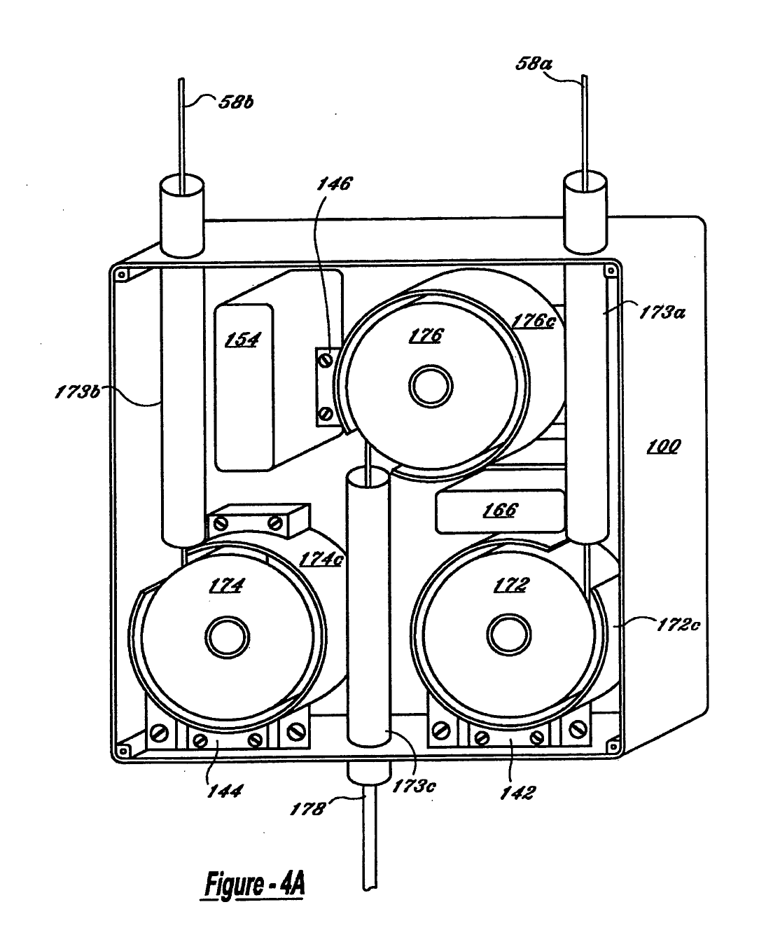

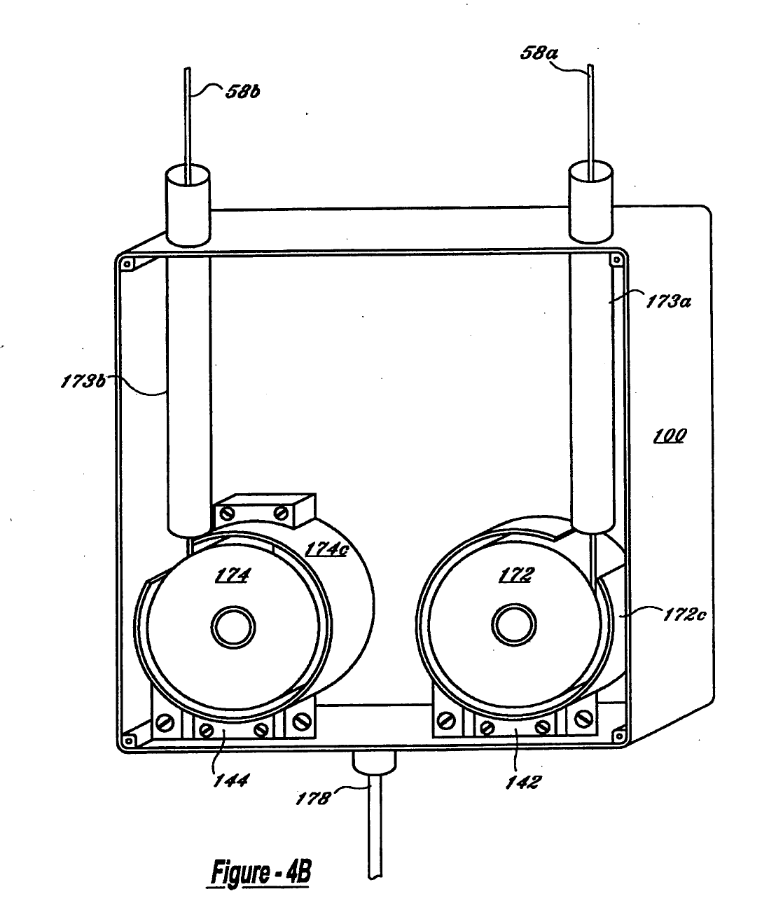

FIG. 3 illustrates a first embodiment of a guidance control system 140. In some embodiments, guidance control system 140 generally consists of a remote control system including at least one servo motor 142 and a remote receiver 154. A remote control 156 may be used to control the descent of the payload 90. A second servo motor 144 and/or a third servo motor may alternatively be used, as illustrated in FIGS. 3, 4A and 4B, and be powered by an internal power supply 166. However, it may be desirable to use only a single servo motor.

At least one servo motor 142, remote receiver 154, and battery power supply 166 may be housed within a control box 100, as shown in FIG. 4A. Control box 100 can be mounted to suspension plate 60 as seen in FIG. 2, using bolts 60d or other suitable means. The one or more servo motors 142 can be electronically connected to remote receiver 154, which can be powered by battery power supply 166. The one or more servo motors 142 can be mounted within control box 100 using screws, bolts or other known, suitable fastening means.

For the embodiments shown in FIGS. 3 and 4A, first, second, and third winch spools 172, 174 and 176 are attached to the output shafts of first, second, and third servo motors 142, 144, and 146, respectively, by a screw or other conventional means. Each winch spool may be substantially surrounded by spool covers 172c, 174c, and 176c. First, second, and third servo motors 142, 144, and 146 are controlled by signals received from remote receiver 154. Depending on the signals received from remote receiver 154, first and second servo motors 142 and 144 turn associated winch spools 172 and 174, either in a clockwise or counterclockwise direction. Steering lines 58a and 58b of ram-air parachute 50 are attached to spools 172 and 174 by conventional means. Steering lines 58a and 58b may be fed through guides 173a and 173b, which exit through the top of control box 100. Spool covers 172c and 174c contain and direct steering lines 58a and 58b around spools 172 and 174, respectively, preventing twisting and tangling. The movement of spools 172 and 174 by servo motors 142 and 144 cause steering lines 58a and 58b to wind in and/or out. Remote receiver 154 may be powered by means such as power supply 166, which may provide 6, 12 or 24 volts DC, depending on the use or preference of the operator, (can vary depending on use) to remote receiver 154. These values are not limiting and the amount of power supplied to remote receiver 154 may also vary depending on the remote receiver 154 selected and the power requirements of the servo or servos used.

The embodiment shown in FIGS. 3 and 4B is a multi-servo embodiment. In it, first and second winch spools 172 and 174 may be attached to the output shafts of first and second servo motors 142 and 144 by a screw or other conventional means. Each winch spool may be substantially surrounded by spool covers 172c and 174c. First and second servo motors 142 and 144 may be controlled by signals received from remote receiver 154. Depending on the signals received from remote receiver 154, first and second servo motors 142 and 144 may turn associated winch spools 172 and 174, either in a clockwise or counterclockwise direction. Steering lines 58a and 58b of ram-air parachute 50 may be attached to spools 172 and 174 by conventional means. Steering lines 58a and 58b may be fed through guides 173a and 173b, which may exit through the top of control box 100. Spool covers 172c and 174c may contain and direct steering lines 58a and 58b around spools 172 and 174, respectively, preventing twisting and tangling. The movement of spools 172 and 174 by servo motors 142 and 144 may cause steering lines 58a and 58b to wind in and/or out. Remote receiver 154 may be powered by means such as power supply 166, which may provide 6, 12 or 24 volts DC, depending on the use or preference of the operator, to remote receiver 154. These values are not limiting and the amount of power supplied to remote receiver 154 may also vary depending on the remote receiver 154 selected and the power requirements of the servo or servos used.

Remote receiver 154 monitors signals being emitted from remote control 156, directing servo motors to turn associated winch spools clockwise or counterclockwise as directed by remote control 156. In some embodiments, the guidance control system may include a digital proportional controller, such that the remote control can more accurately control the speed and degree to which the servo motor or motors turn. Each servo motor may allow 6-8 full rotations, but more or fewer rotations may be possible so that steering lines 58a and 58b may be controlled as desired.

Remote control 156 may allow a user to control the servo or servos, preferably by the movement of one or more joysticks 156a, 156b, which, in turn, may cause the movement of servo motors and associated winch spools. Guidance control system 140 allows aerial delivery system 10 to be steered and guided towards the intended destination by remote control 156, as steering lines 58a and 58b associated with ram-air parachute 50 are connected to winch spools 172 and 174. Thus, the ultimate movement of winch spools by corresponding movement of the joysticks 156a and 156b, may cause steering lines 58a and 58b to correspondingly move to guide aerial delivery system 10 to its destination.

Referring to FIG. 5, in some embodiments, at a pre-selected altitude above the targeted area, recovery parachute 70 may be deployed. The altitude selected may be relatively low, depending on the size of the recovery parachute 70 being used and the weight of payload 90, so that payload 90 spends a reduced period of time in the air. The activation of recovery parachute 70 can be achieved in numerous ways, for example, (1) power voltage through a wire from the receiver to a pyrotechnic cutter on a pilot chute; (2) the ram-air parachute being released from the payload and extracting recovery parachutes(s); (3) remote activation from the receiver to activate the pyrotechnic cutter; and/or (4) automatic activation device activating a pyrotechnic cutter on the payload. Other ways of activation known in the art are also contemplated.

In the exemplary embodiment shown in FIG. 3, FIG. 4A and FIG. 5, the recovery parachute 70 may be attached via a durable enclosed deployment cable 178 to a third winch spool 176 associated with a third servo 146. Cable 178 may be fed through guide 173c to prevent tangling. Spool cover 176c may further contain and direct cable 178 around spool 176, preventing twisting and tangling. The deployment sequence of recovery parachute 70 may be controlled by switch 156c, which may operate a separate channel of remote control 156. Upon engaging switch 156c, third winch spool 176 winds in the rip cord of parachute 70 via deployment cable 178, which may trigger the deployment and subsequent inflation of recovery parachute 70. Once recovery parachute 70 is fully inflated, ram-air parachute 50 may be caused to at least partially collapse, thereby reducing drag so that recovery parachute performance is not hindered. In some of the embodiments for deploying recovery parachute 70 discussed above, deployment may be initiated by the release of ram-air parachute 50 which can be attached to recovery parachute 70 by an extraction bridle. Deployment cable 178 can be attached to a cutter, which activates a plurality of ring release mechanisms, which can be used to attach ram-air parachute 50, to the control box 100 or the suspension plate 60 at attachment points 60a and 60b. Upon engaging switch 156c, third winch spool 176 winds in deployment cable 178, which activates the release of ram-air parachute 50, which pulls recovery parachute 70 out from within its container so that it may inflate.

Recovery parachute 70 may be a conventional round recovery type parachute used for the delivery of cargo. Since at the time of deployment of recovery parachute 70, aerial delivery system 10 may be traveling at a high velocity, a pilot chute and recovery parachute(s) 70 can be located so that they deploy downwind, thereby being drawn behind payload 90. Otherwise, recovery parachute 70 may be slow in opening, may get tangled, or may not open due to the impacting wind velocity. To avoid this, recovery parachute 70 may be attached to the heaviest side of payload 90, or, if payload 90 is balanced, a wind sock and/or pilot parachute may be attached to recovery parachute 70 to assure that it is drawn behind payload 90 while in flight. The size of the canopy of recovery parachute 70 can range from several hundred feet to several thousand feet depending on the weight of the payload 70, among other things. Further, if a soft landing is desired by, for example, the fragility of payload 70 or for other reasons, or if large payloads are desired (e.g., 5,000 to 12,000 pounds or greater) then multiple recovery parachutes can be used at one time and/or larger canopies can be selected. Conversely, if a rapid descent with reduced drift is desired, a smaller canopy can be selected. The cargo descends the remainder of the distance under recovery parachute 70 generally as shown in FIG. 5.

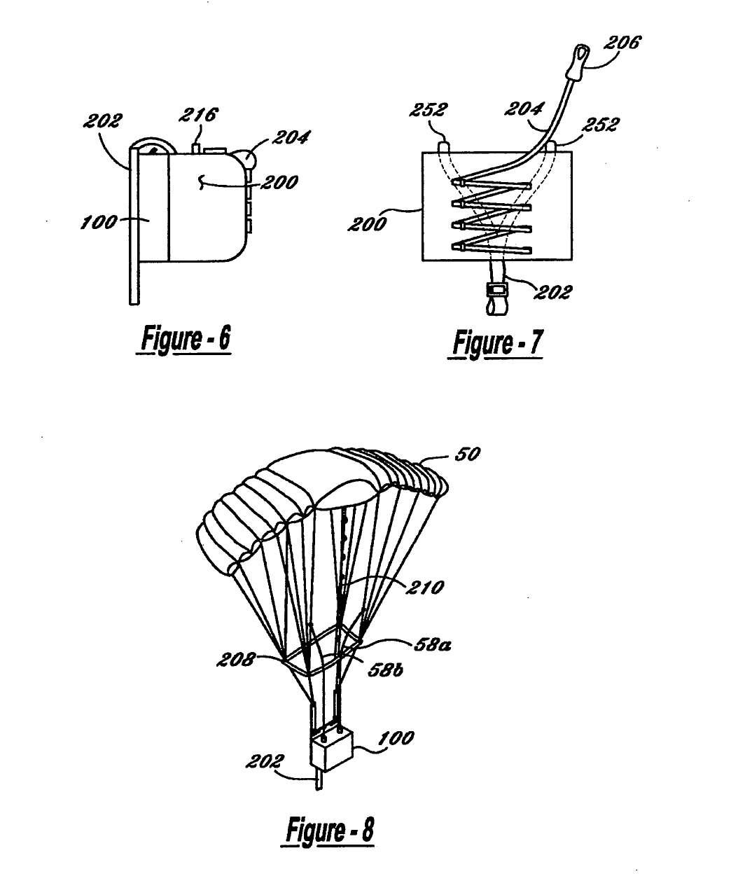

Alternative embodiments are shown in FIGS. 6-8. As shown, before deployment, ram-air parachute 50 may be placed in a deployment bag 200. The bag 200 may be of any shape, size or material suitable for containing a parachute before deployment. Ram-air parachute 50 within the bag 200 may be attached to a riser 202 located on or near the control box 100.

As shown in FIG. 7, ram-air parachute 50 may be removed from the deployment bag 200 by use of a static line 204 and snap 206, or equivalent means.

Separated access points 252 for control lines and/or suspension lines, and the riser 202 are also shown in FIG. 9. FIGS. 10A and 10B show an embodiment having additional access points 254 for control lines. Ram-air parachute 50 is shown deployed in FIG. 8. In this embodiment, deployment velocity and force of ram-air parachute 50 may be controlled through the use of a slider 208 used in conjunction with brake lines 210. In some embodiments, four brake line loops may be used; however, one of skill in the art will recognize that the number of brake line loops can be varied.

Other equivalent means for controlling deployment of ram-air parachute 50 are known in the art and are contemplated. Aerial delivery system 10, after it has been dropped from an altitude and before full deployment of ram-air parachute 50, is shown in FIG. 9. As shown, the slider 208 is not yet in full deployment. The brake line 210 may allow the slider 208 to travel down the suspension lines 56 in an incremental fashion. However, other means known in the art for incrementally, or slowly, sliding the slider 208 down the control lines 56 are also contemplated. As shown in FIGS. 6-9, a riser 202 may be located below the control box 100.

In some embodiments, autonomous navigation of aerial delivery system 10 may be desirable. Therefore, aerial delivery system 10 may include components enabling such autonomous navigation, including determination of a drop zone, determination of a flight plan, determination of a recovery parachute opening point, and/or automatic control of aerial delivery system 10.

In such embodiments, guidance control system 140 may include a control box 100, which is shown schematically in FIG. 9 and in FIGS. 10A and 10B, which may include a receiver 214, a compass 220, an altimeter (not shown), a gyroscope 222, and/or a processor 221, among other things. As shown in FIG. 10A, a cover associated with control box 100 has been removed, and riser 202 is shown behind the control box 100. Left steering line 58a and right steering line 58b interact with a single servo motor 142 in connection with a gear box 212 and/or a winch spool (not shown). As noted above, each of left steering line 58a and right steering line 58b may be operably connected to steering lines associated with ram-air parachute 50.

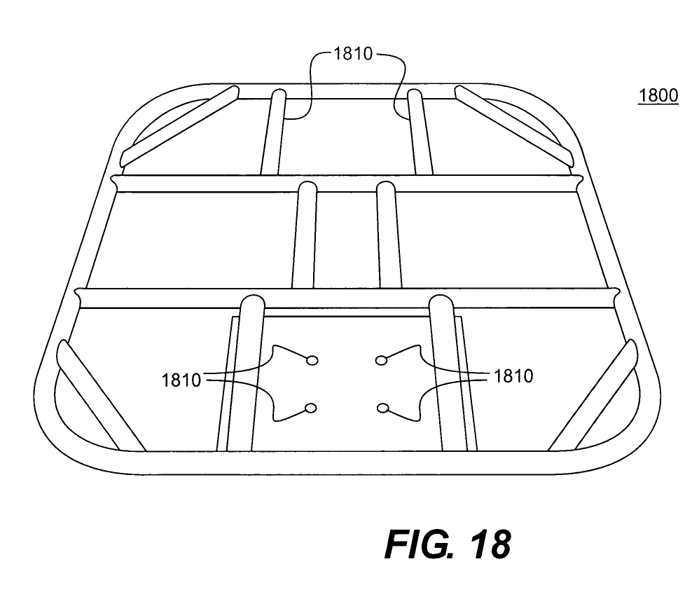

Risers 202 may be attached to the back of the control box, as shown in FIG. 10B. However, other equivalent configurations are also contemplated, such as utilization of dual risers affixed to each face of control box 100, among others. Risers 202 may be configured to be removably attached to mantle 1800 (shown in FIG. 18) via connection points 1810, ram-air parachute 50, and/or recovery parachutes 70, as desired.

In one embodiment, a receiver 214, for example, a global positioning system (GPS) device and/or radio receiver may be associated with control box 100, and used to receive information related to position of aerial delivery system 10. Such information may be utilized by processor 221 for purposes of controlling a direction of descent associated with aerial delivery system 10, among other things. Receiver 214 may be configured to receive information from various sources (e.g., GPS satellites, wireless/wired network, etc.) and provide such information to processor 221. For example, receiver 214 in conjunction with antenna 216, and/or an internal interface (not shown) may be used to either receive or transmit coordinates (e.g., latitude, longitude, and/or altitude) for the delivery of the payload, i.e., location information associated with a target location. In such an example, an operator may provide latitude and longitude information related to a target location via a wireless/wired network, to be received, via antenna 216, by receiver 214. Receiver 214 may then provide such location information to processor 221 or other suitable device associated with control box 100. In addition, receiver 214 may receive information from various satellites and/or repeaters associated with GPS network for purposes of providing and/or determining position, velocity, and altitude information related to aerial delivery system 10 once deployed. For example, utilizing information provided by a GPS network through receiver 214, processor 221 may determine a precise location of aerial delivery system 10 in relation to a target location.

Additional information may also be provided via receiver 214, for example, ambient condition data (e.g., wind velocities, wind profiles, etc.). One of ordinary skill in the art will recognize that receiver 214 may include one or more receiver devices. For example, receiver 214 may be broken out into a separate GPS receiver and/or a separate wireless/wired network receiver. Alternatively, a single receiver 214 may include all desired functionality (e.g., wireless/wired network and GPS, among others). All such configurations are contemplated by the present disclosure.

Processor 221 may include any type of processor capable of receiving information, executing instructions, and/or providing output (e.g., control signals). For example, processor 221 may include a computer or other circuitry configured to perform similar operations. Processor 221 may be configured to receive information, for example, location information related to a target location, ambient condition information, and/or other suitable information from components associated with aerial delivery system 10 (e.g., receiver 214) and/or external sources (e.g., wind profile information via a wireless/wired network).

Processor 221 may further be configured to determine, based on various factors (e.g., target location, wind velocity profile, and/or aircraft velocity, among others) an aerial delivery system deployment zone, a recovery parachute opening point, and flight plan (e.g., sweeping circle, random turn, and/or centered FIG. 8), among other things. For example, based on a particular wind profile, aircraft altitude, and aircraft velocity, processor 221 may determine an appropriately sized drop zone where aerial delivery system 10 should be deployed from the aircraft for substantial accuracy of the delivery.

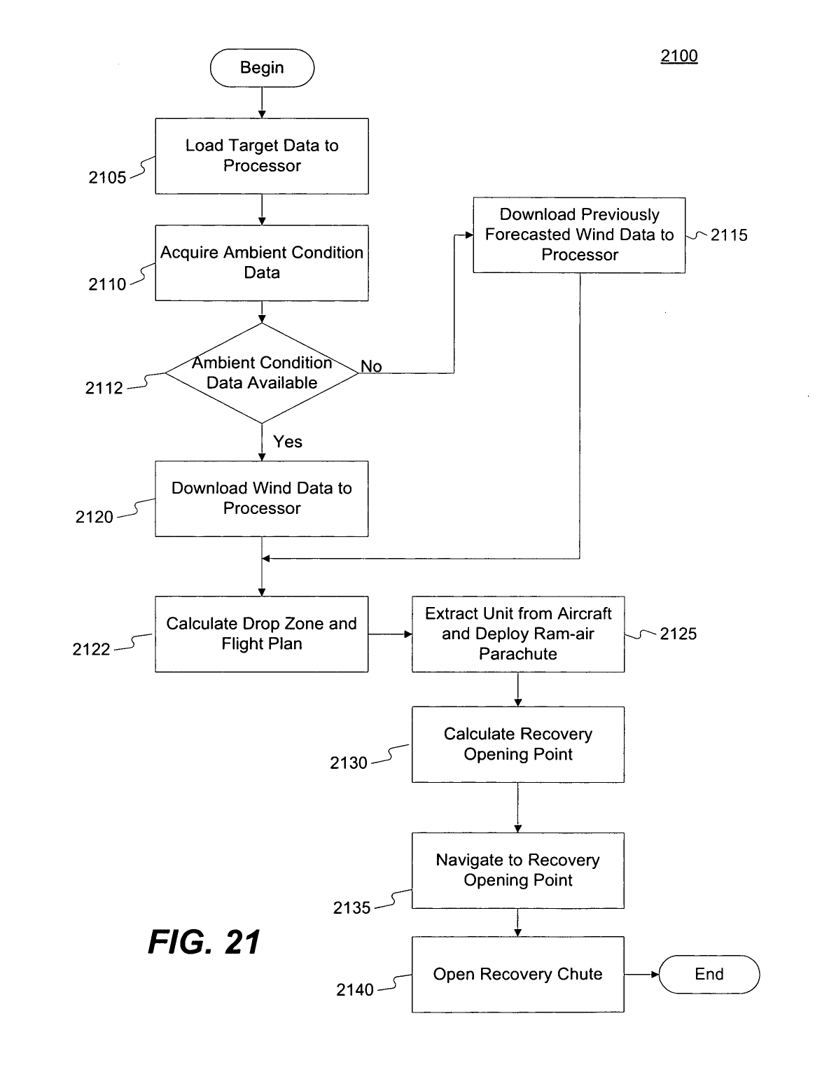

Processor 221 may further be configured to provide various control signals related to calculations and determinations made by processor 221. For example, processor 221 may determine, based on a wind profile, aircraft velocity, aircraft altitude, and/or flight plan that a drop zone for aerial delivery system 10 is a circle approximately 1.5 miles in diameter. Therefore, prior to deployment, but while an aircraft is within the determined drop zone, processor 221 may cause an indication (e.g., flashing indicator, buzzer, etc.) that aerial delivery system 10 should be deployed from the aircraft. Further, processor 221 may determine that a recovery parachute opening point is a location upwind of the target location approximately 1200 feet lateral distance and 700 feet vertical distance from the target location. Therefore, upon navigating to, and determining that aerial delivery system 10 has reached such a point, processor 221 may issue a control signal configured to cause a cutter or other device to release a pilot chute and/or a drogue parachute associated with one or more recovery parachutes 70. Such functionality will be described in greater detail with reference to FIG. 21.

Coupled with processor 221 may be a storage device (not shown) for receiving, storing, and/or providing data to processor 221. For example, storage device may include random access memory RAM (e.g., flash card), hard disk storage, read-only memory (ROM), and/or any other suitable memory. In some embodiments, a flash card may be pre-loaded with location information associated with a target and ambient condition information (e.g., wind profile). Such a flash card may then be inserted into a receiving device (not shown) in communicative connection with processor 221, and preconfigured to receive such a flash card. Processor 221 may then read data stored on such a memory device.

Compass 220 may be configured to provide directional information in addition to that provided by a GPS receiver (e.g., receiver 214), while gyroscope 222 may provide acceleration information (e.g., directional changes) and navigation assistance, among other things. Altimeter (not shown) may provide altitude information in addition to altitude information provided by a GPS receiver, such as receiver 214.

Servo 142 and other devices associated with the control box 100 may be configured to manipulate the one or more steering lines associated with ram-air parachute 50 and may be powered by one or more power supplies (e.g., batteries 224) associated with control box 100. Servo 142 may further receive signals (e.g., from processor 221) based on information obtained from receiver 214, compass 220, gyroscope 222, and/or altimeter (not shown). For example, during descent of aerial delivery system 10, where processor 221 has determined a flight plan (e.g., sweeping circle, random turn, centered FIG. 8, etc.) servo 142 may rotate a winch spool associated with servo 142 clockwise or counterclockwise, thereby causing right and left steering lines 58a and 58b to pull right or left on ram-air parachute 50, such that the flight plan and navigation is substantially accomplished by aerial delivery system 10.

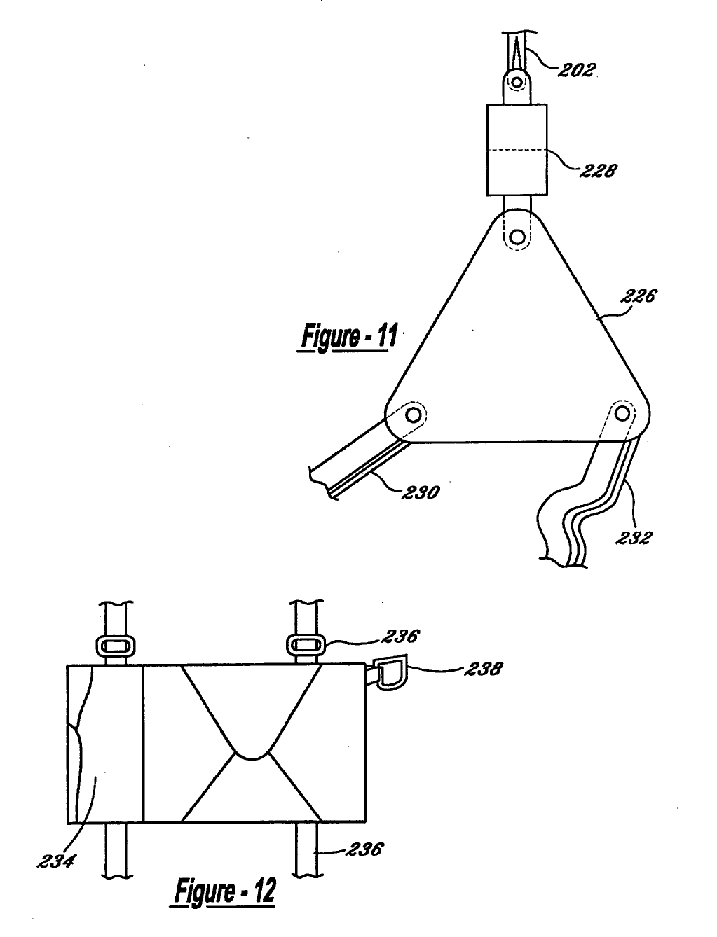

As shown in FIG. 11, riser 202 may be attached to a means for separating attachment points, such as polygonal link 226. As shown, riser 202 may be connected to the polygonal link 226 with a means for reducing the risk of tangling, such as a swivel 228.

Furthermore, payload riser 230 and recover parachute riser 232 may be separated on the link 226. The distances between the ram riser 202, the payload 230, and the recovery riser 232 may prevent tangling and mishap between ram-air parachute 50, the recovery parachute and the payload. A triangle-shaped link 226 as illustrated in FIG. 11 may be used and/or other shapes, such as square and rectangular as desired.

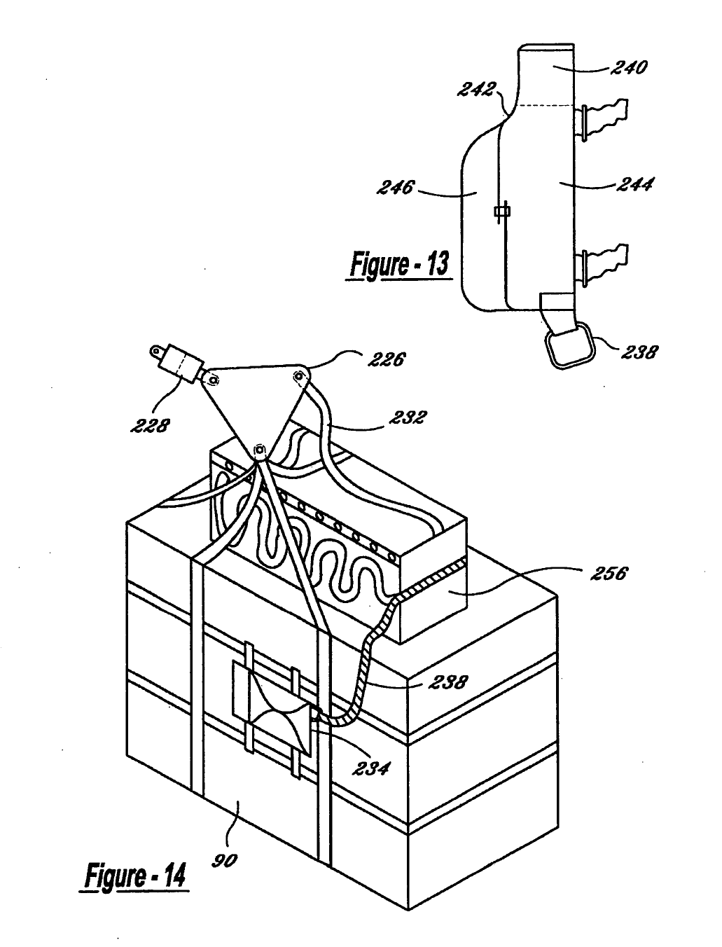

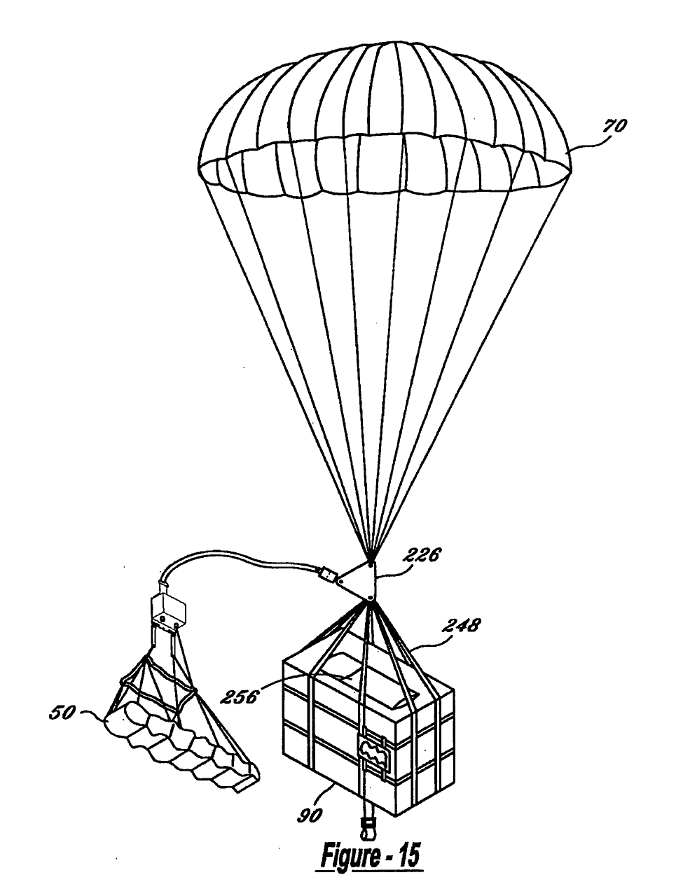

An exemplary recovery parachute activation system of the aerial delivery system 10 is shown in FIGS. 12 and 13. An automatic device or activation sensor may be placed within a container 234. It may be desirable that the container 234 further includes fastening straps 236 (e.g., nylon webbing material) or other suitable connectors, for attachment to the payload. The activation system may be then attached to the recovery parachute, preferably by means such as a bridle 238. However, other equivalent means for attachment are also contemplated herein. As shown in FIG. 13, the automatic activation device may be in a separate compartment 242 of a container, having multiple purposes. The container 242 may also have a compartment for the drogue parachute 244 and a separate compartment 246 for a pilot chute for the drogue parachute. The automatic activation device may include any suitable device for causing deployment of one or more recovery parachutes, such as, for example, a pyrotechnic or mechanical cutter and/or a ram-air release.

An illustration of another embodiment of a recovery system before deployment is shown in FIG. 14. The polygonal link 226 is shown having the swivel 228 for ram-air parachute 50 (not shown). The link 226 may also be attached to the recovery parachute riser 202, which may be connected to the recovery parachute 70 located within a container 256. Recovery parachute 70 may be attached by bridle 238 to the recovery parachute activation system container 234. Thus, connection between ram-air parachute 50 and recovery parachute and cargo may be spaced sufficiently apart for safe deployment.

Deployment of the recovery parachute 70 for this embodiment is illustrated in FIG. 15. As shown, the polygonal link 226 may be an attachment to the recovery parachute 70, the ram-air parachute 50, and the payload 90. Attachment may be made by a cargo harness 248. As shown, when the recovery parachute 70 deploys, the ram-air parachute 50 becomes deflated. Because of the separating link between ram-air parachute 50 and the recovery parachute, there may be a decreased chance of the parachutes becoming tangled. Furthermore, the container for the recovery parachute 250 may be firmly attached to the cargo 90 for reuse.

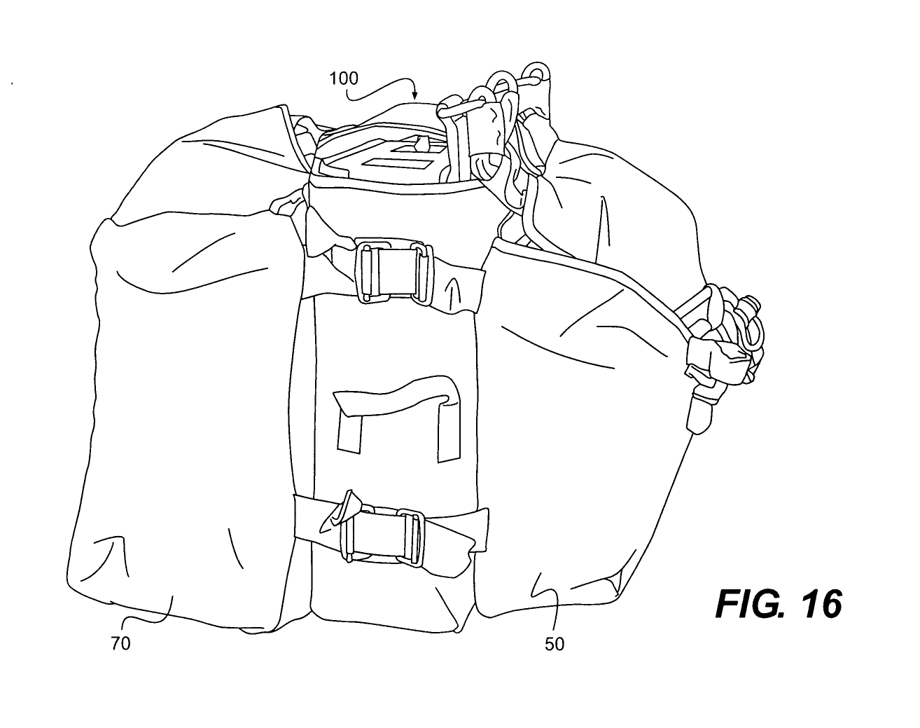

FIG. 16 is a depiction of another exemplary aerial delivery system 10 consistent with the present disclosure. In such embodiments, aerial delivery system 10 may include control box 100, ram-air parachute 50, recovery parachute 70, a mantle 1800 (shown in FIG. 18), and various other components. In some embodiments, components of aerial delivery system 10 may be in close proximity to one another, so as to enable simplified packing and storage of the components. For example, as shown in FIG. 16, control box 100 may be sandwiched between ram-air container 1620 and recovery container 1625. The resulting package may then be removably attached to a cargo system, utilizing a mantle, webbing, or other suitable connectors. Such a configuration may be beneficial in medium cargo applications (e.g., 500 to 4000 pounds).

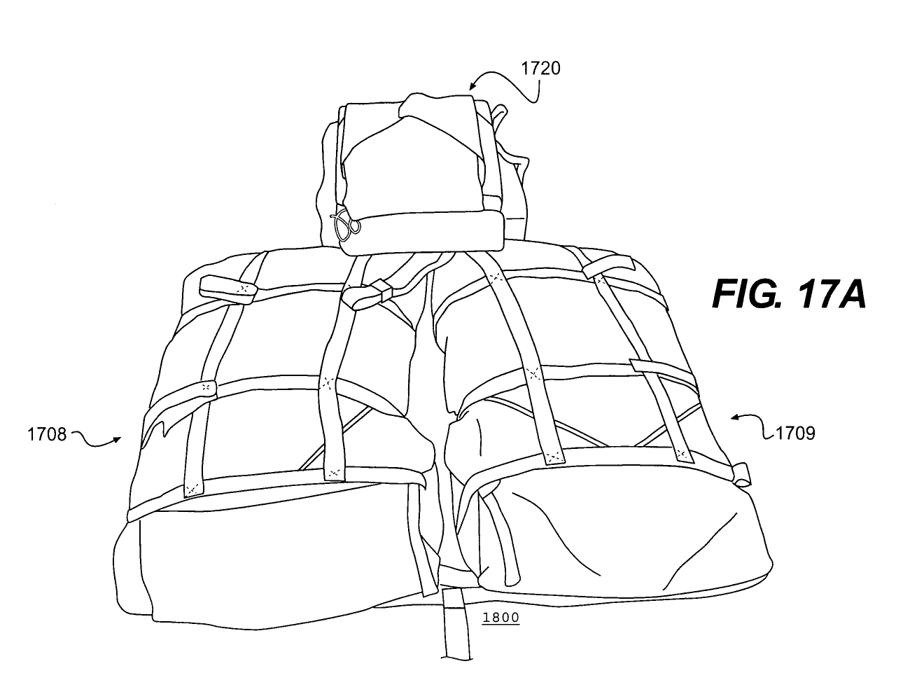

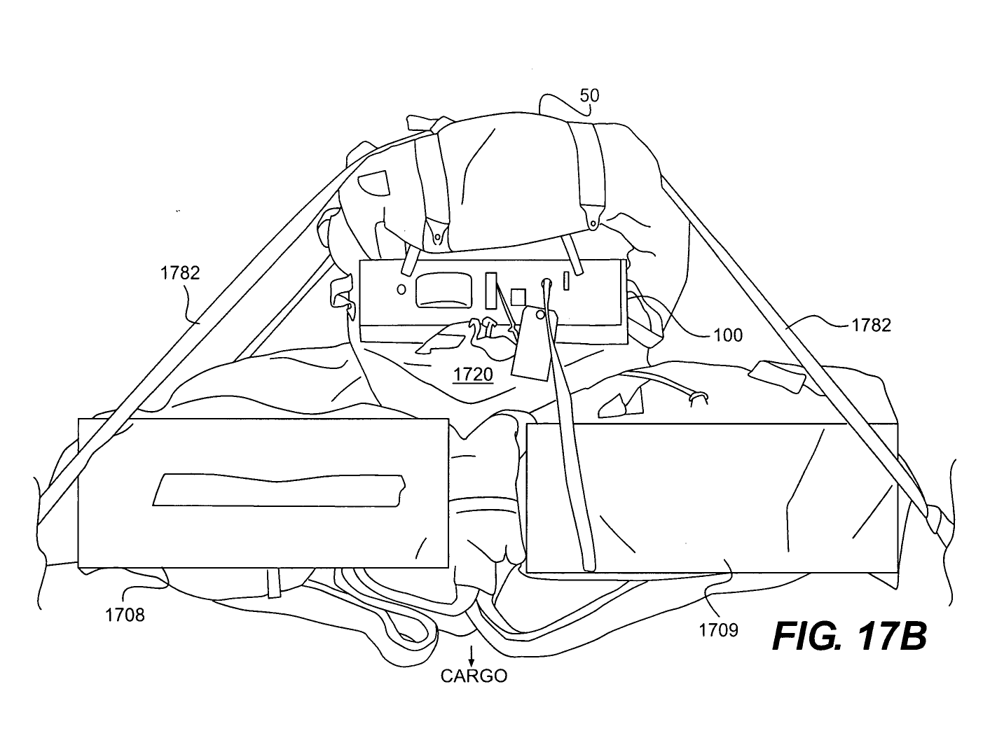

FIGS. 17A and 17B are depictions of exemplary large load aerial delivery systems, including mantle 1800, containers 1708 and 1709 housing recovery parachutes 1710 and 1711, and release container 1720. Large load aerial delivery systems may be configured to deliver loads in excess of 5,000 pounds. For example, some systems may be configured to deliver loads between 10,000 and 15,000 pounds. In such systems, it may be desirable to implement one or more recovery parachutes in addition to ram-air parachute 50 (see FIG. 9). As shown in FIGS. 17A and 17B, two recovery parachutes 1710 and 1711 may be packed separately within containers 1708 and 1709, and mounted to mantle 1800 via any suitable mounting method (e.g., nylon webbing, brackets, clamps, etc.). Recovery parachutes 1710 and 1711 may include, for example, G-11 parachutes, G-12 parachutes, or any other suitable canopy for a desired load. In addition, it is important to note that while embodiments are described with regard to two recovery parachutes, any number of recovery parachutes may be used as desired. Also shown in FIG. 17B, tie-down straps 1782 (e.g., nylon webbing) may be used to hold components of aerial delivery device in place during transport.

FIG. 18 is a depiction of an exemplary mantle 1800 configured to support ram-air parachute 50, recovery parachutes 1710 and 1711, and a cargo (not shown). Mantle 1800 may further provide a removable connection between cargo, recovery parachute 70, and ram-air parachute 50, via, for example, connection points 1810. Mantle 1800 may be of various configurations and may be designed based on a load associated with a cargo for delivery. For example, mantle 1800 may be fabricated of tubular steel, aluminum, or other material based on a desired strength and rigidity, among other things. Where tubular steel is used, pieces of mantle 1800 may be assembled via welding and/or brackets. One of skill in the art will recognize that varying techniques for design and assembly of mantle 1800, may be used without departing from the scope of the present disclosure.

Connection points 1810 associated with mantle 1800 may include passages configured to receive fasteners, beams configured to accept clamps, and/or other suitable points for affixing lines or clips. Connection points 1810 may be located at various points associated with mantle 1800 and such locations may be designed to bear a load associated with a particular connection.

Further, connection points 1810 may be configured to allow for removal of cargo from mantle 1800 without a complex array of tools available to a team on the ground. For example, quick release fittings (e.g., carabiners) and/or specially designed connectors may be used to limit the number of tools a ground team may use for removal of cargo. In another example, connection points 1810 and associated connectors may be configured to be disassembled with only a screwdriver and/or wrench.

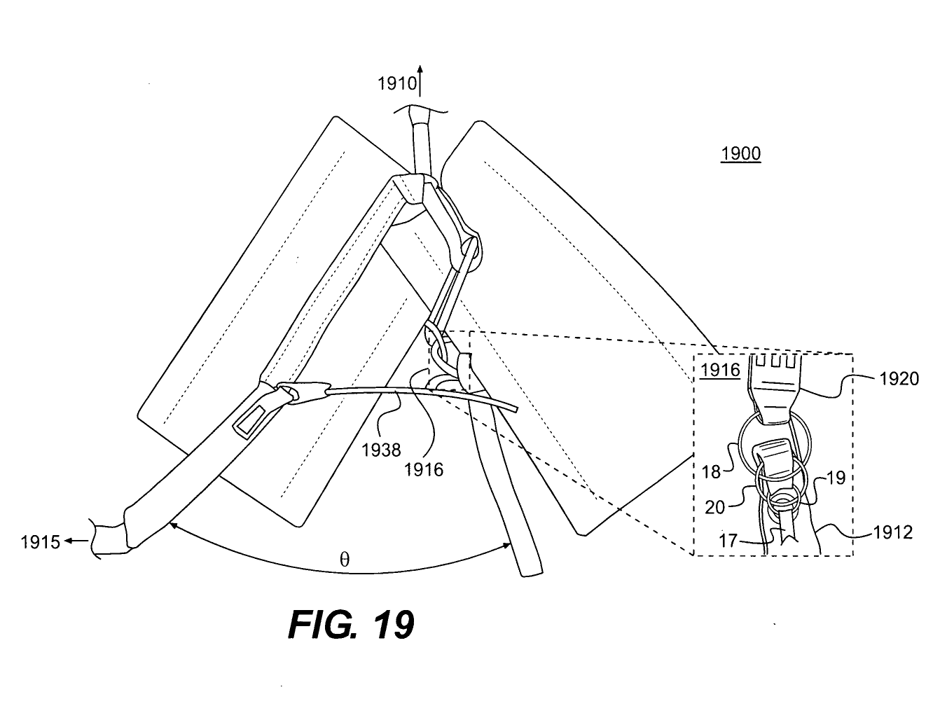

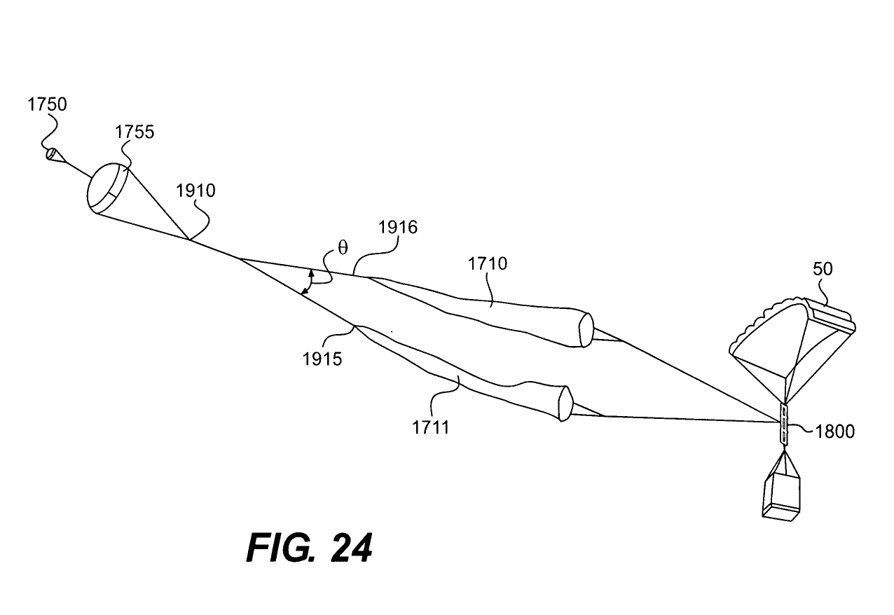

Release container 1720 may include a pilot parachute 1750 (see FIG. 24), a drogue parachute 1755, and a release bridle 1900 (see FIG. 19). A release mechanism associated with container 1720 (not shown) may be configured to be in operable connection with control box 100, such that upon receiving a control signal at recovery parachute release point, release mechanism may cause container 1720 to open thereby releasing pilot parachute 1750.

Pilot parachute 1750 may be configured to be released into an air stream associated aerial delivery system 10, and to exert a force on drogue parachute 1755. Therefore, pilot parachute 1750 may include riser lines or other suitable connectors connecting to a crown (e.g., top) of drogue parachute 1755. Drogue parachute 1755 in turn may be affixed to release bridle 1900 and configured to exert a force on release bridle 1900.

FIG. 19 is a depiction of an exemplary release bridle for embodiments of aerial delivery system 10 using more than one recovery parachute. Release bridle 1900 may include a first end 1910, configured to be affixed to drogue parachute 1755. For example, first end 1910 of release bridle 1900 may be affixed to the risers or any other lines associated with drogue parachute 1755.

Release bridle 1900 may further include a fixed end 1915, configured to be affixed to one of recovery parachutes 1710 or 1711. For example, fixed end 1915 may be affixed to the crown of recovery parachute 1711 via webbing or other suitable material. Alternatively, recovery parachute 1711 may include a connecter at its crown configured to fixedly connect with fixed end 1915 of release bridle 1900.

Release bridle may further include one or more release ends 1920, configured to be releasably connected to recovery parachute 1710 and/or additional recovery parachutes. As can be seen in the expanded portion of FIG. 19, release ends 1920 of release bridle 1900 may include an operable connection to a first section of multi-ring release system 1916. Multi-ring release system 1916 may be configured to allow release end 1920 to breakaway from connection line 1912 upon a predetermined value for angle θ (FIG. 24). A first section of multi-ring release system 1916 may include a first ring 19, a second ring 20, and possibly also as many additional rings as desired. Although multi-ring release system 1916 will be described in the context of a three-ring system in this description, more or fewer rings may be used as desired. For example, a multi-ring release system may include three, four, five, six, or more rings, depending on numerous factors, such as potential load, among other things. Further, any ordinal identifier (e.g., first, second, etc.) used throughout this specification to reference a ring associated with multi-ring release system 1916 is intended to be exemplary only and not to denote absolute order of rings or number of rings present in multi-ring release system 1916. As noted, more or fewer rings may be utilized and any suitable natural number may be used to reference a ring in multi-ring release system 1916. Moreover, rings associated with multi-ring release system 16 may not be limited to an annular shape and may be of any size and shape as desired.

First ring 19, second ring 20, as well as any additional rings, may be operably connected to connection line 1912 using, for example, looped fabric, fasteners, eyelets, or other suitable fastening mechanisms. In one example, webbed nylon loops may be affixed (e.g., sewn, riveted, etc.) to connection line 1912 with first ring 19 and second ring 20 passing through the openings created by the loops, as shown. Load ring 18 may be operably connected to release end 1920 of release bridle 1900. Such a connection may be achieved using one or more types of connector structures such as, for example, fabric loops, grommets and fasteners, or any other suitable method.

Based on such a configuration, second ring 20 may be passed through load ring 18, and first ring 19 passed through second ring 20, with each ring pivoting to restrain the ring before it. First ring 19 may be restrained, as shown, by a cord section 17 configured to pass over first ring 19 and through first segment of material 10 (e.g., through a grommet). Cord section 17 may include a loop through which a retaining pin 1938 may be passed, thereby substantially preventing cord section 17 from releasing first ring 19 until retaining pin 1938 is slidably removed (e.g., when angle θ reaches a predetermined value).

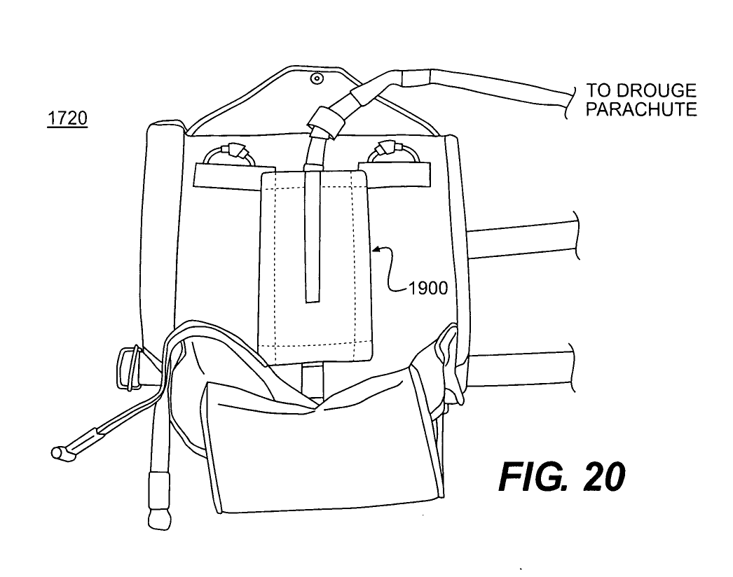

FIG. 20 is a depiction of an exemplary rigging for release bridle 1900. As shown in FIG. 20, release bridle 1900 may be packed within container 1720 prior to pilot parachute 1750 and drogue parachute 1755. In some embodiments, a protective covering may be applied to release bridle 1900 (e.g. nylon webbing, kraft paper, etc.) to prevent chaffing between components.

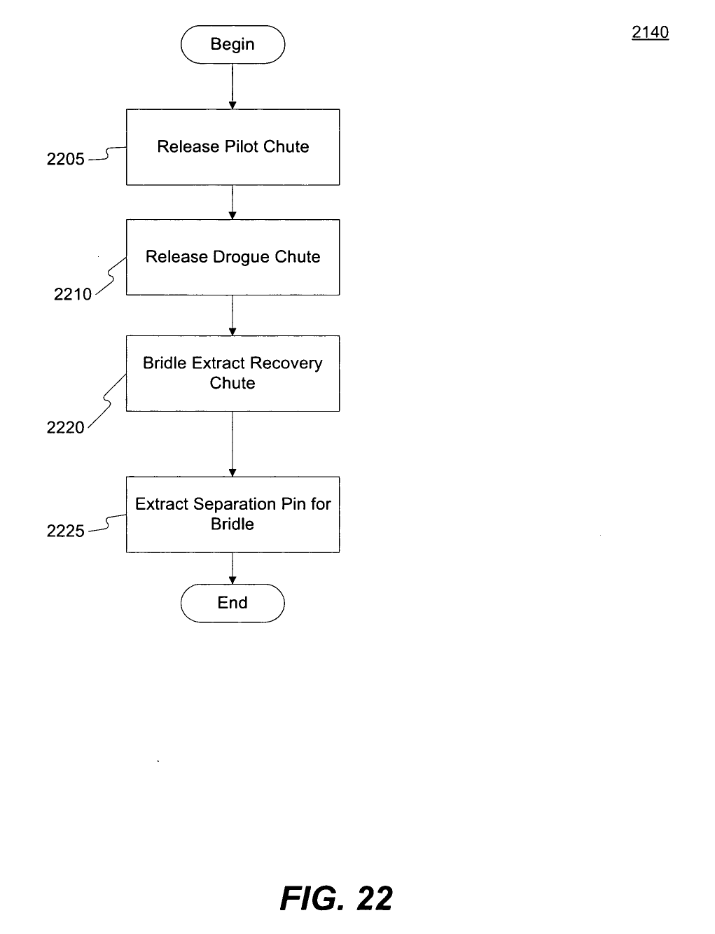

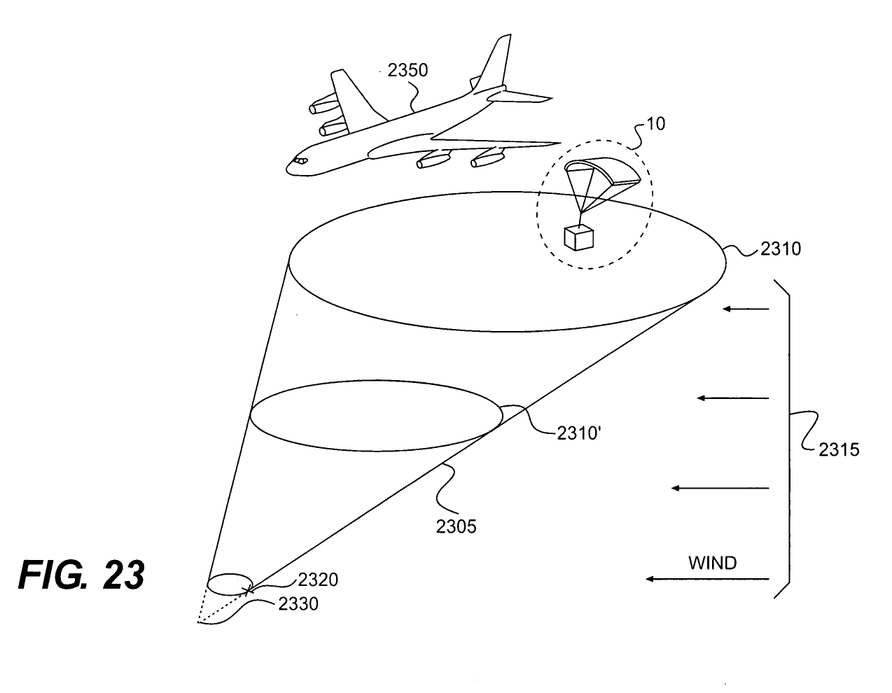

FIG. 21 is a block diagram 2100 highlighting an exemplary method for aerially delivering cargo system from an aircraft at altitude. Throughout the discussion associated with FIGS. 21 and 22, reference may be made to FIGS. 23 and 24 for sake of clarity.

Information related to a target location may first be provided to processor 221 for storage in associated memory (step 2105). For example, location information may include a latitude, a longitude, and/or an altitude of a particular target area where cargo should be delivered. Such information may be provided to processor 221 via receiver 214 over a wireless/wired network, or any other suitable method (e.g., via a flash memory card). Further, such information may be provided to processor 221 at any time, e.g., prior to loading aerial delivery system 10 into an aircraft, in advance prior to rigging of control box 100 to a completed aerial delivery system 10, and/or within an aircraft.

In some embodiments, ambient condition information (e.g., actual wind profile data 2315 (shown in FIG. 23) may be acquired by various methods (e.g., a sonde dropped from the aircraft) and provided to systems associated with an aircraft and/or directly to processor 221 (step 2110). For example, where a sonde is dropped from altitude, wind profile information (i.e., velocity at various altitudes) may be acquired as the sonde falls through the atmosphere. Information related to wind conditions at predetermined intervals may subsequently be relayed from the sonde back to the aircraft (step 2112: yes). The aircraft may then relay such information to processor 221, via a wireless/wired network and/or receiver 214 to be stored in a storage device (e.g., flash RAM) for determination of a drop zone (step 2120).

Alternatively, where no sonde or other such probe is available and/or where ambient condition information cannot be obtained (step 2112: no), forecasted data may be provided to processor 221 (e.g., winds aloft forecast) (step 2115). Such provisioning may be performed via manual entry, weather service download via a wireless/wired network (e.g., to receiver 214), or any other suitable method. Such information may also be provided to a flash ram card which may subsequently be provided to control box 100 and processor 221.

Once target location information and ambient condition information has been provided to aerial delivery system 10, a drop zone and a flight plan may be determined by processor 221 (step 2122). FIG. 23 depicts an exemplary drop zone 2310, determined based on various ambient 2315 and aircraft 2350 conditions present at a drop time, and a target location 2330. Instead of (or in addition to) utilizing a CARP, embodiments of the present disclosure may utilize a drop zone 2310, or drop area for deploying aerial delivery system 10 from an aircraft. Such an area may be calculated based on ambient condition information (e.g., wind profile 2315), target location 2330, and/or condition information associated with aircraft 2350 (e.g., aircraft velocity), among other things. For example, a calculated drop zone 2310 may be defined by a base of an inverted cone 2305 with an apex at the target location 2330, the base being at the altitude of the aircraft. The size of drop zone 2310 may decrease as the aircraft descends to lower altitudes, as shown at drop zone 2310′. The cone may be oblique based on a position of the aircraft and wind profile 2315, among other factors. As can be seen, the size of drop zone 2310 varies depending on vertical distance (altitude) from a target location. Generally, aerial delivery device 10 may be deployed anywhere within the area defined by a frustum surface (e.g., 2310, 2310′) of the inverted cone at a given altitude, and may still accurately reach the target location. Such an embodiment is less rigid than utilization of a CARP, and may allow aircraft to avoid potentially hazardous airspace, while still providing for accurate delivery.

Determined flight plans associated with an autonomously guided aerial delivery system 10 may include a sweeping circle, a random turn, and/or a centered FIG. 8. A sweeping circle flight plan may comprise navigating aerial delivery system 10 in a circular fashion while maintaining the target location substantially at the center of the sweeping circle. Thus performing a spiraling like maneuver through descent of aerial delivery system 10.

A random turn flight plan may comprise navigating aerial delivery system 10 such that turns back toward the target location are initiated by aerial delivery system 10 whenever a lateral distance from target location exceeds a predetermined threshold. For example, as aerial delivery device 10 descends from an altitude, wind profile 2315 may cause aerial delivery system 10 to fly away from target location 2330. Therefore, aerial delivery system 10 may initiate a turn back toward target location 2330. However, as aerial delivery system 10 continues to pass target location 2330, another turn may be initiated back toward target location 2330, and with the wind. Each of these turns may be pseudo-random, in that the wind profile may change and length of time travelling in each direction prior to another turn back may vary.

A centered FIG. 8 flight plan may comprise navigating aerial delivery system 10 in a FIG. 8 pattern throughout descent, while maintaining target location 1630 at the center of the FIG. 8. Similar to the sweeping circle flight plan, aerial delivery device may maintain substantially similar turn patterns for each turn while maintaining target location 2330 at the center of the pattern. Such a pattern may be beneficial when a reduced speed descent is desired.

Once a drop zone and a proposed flight plan have been determined, indicators associated with control box 100 may indicate when aerial delivery system should be deployed from aircraft 2350, at which point aerial delivery system 10 may be jettisoned from aircraft 2350, and ram-air parachute 50 deployed (step 2125).

Determination of a recovery parachute opening point 2320 (step: 2130) may be made prior to deployment from aircraft 2350 and/or after such deployment. Further, such a determination may be based on ambient condition information (e.g., wind profile 2315), target location 2330, and/or opening profiles associated with one or more recovery parachutes (e.g., recovery parachutes 1710 and 1711), among other things. For example, where wind profile 2315 indicates strong surface level winds, a recovery parachute opening point 2320 may be determined to be at a lower altitude than when surface level winds have been determined to be light and variable.

Recovery parachute opening point 2320 may be determined to fall at a determined altitude and upon a final turn into the wind during navigation of the flight plan determined at step 2122. For example, where a sweeping circle flight plan has been determined, recovery parachute opening point 2320 may be determined to be at a point 700 vertical feet from target location 2330 and 1400 later feet upwind from target location 2330. Therefore, following deployment of one or more recovery parachutes, aerial delivery device may glide with wind profile 2315 to target location 2330.

Once recovery parachute opening point 2320 has been determined (step 2130), control box 100 may cause aerial delivery system 10 to navigate to recovery parachute opening point 2320 through the determined flight plan. As described above, ram-air parachute 50 may be caused to fly the determined flight plan via steering lines 58a and 58b, servo motor 142, and/or a winch spool. Receiver 214 may continually receive GPS information and provide such information to processor 221 for determining whether the determined flight plan is being accurately carried out and whether aerial delivery system 10 remains on target for recovery parachute opening point 2320. Where processor 221 determines that the flight plan has been compromised, processor 221 may issue a control signal configured to bring aerial delivery system 10 back into compliance with the flight plan. For example, where processor 221 determines that a wind profile 2315 change has caused left deviation in a path associated with aerial delivery device 10, processor 221 may issue a control signal to servo motor 142 causing a winch spool to pull steering line 58a causing a right turn to be executed via ram-air parachute 50. Likewise, where a right deviation is detected by processor 221, processor 221 may issue a control signal to servo motor 142 causing a winch spool to pull steering line 58b, thus causing a left turn to be executed by ram-air parachute 50. Upon determination by processor 221 that aerial delivery device 10 has returned to the determined flight plan, processor 221 may issue a control signal causing the flight plan to be resumed. One of ordinary skill in the art will recognize that numerous navigation sequences may be implemented to cause aerial delivery device 10 to navigate to recovery parachute opening point 2320. All such sequences are within the scope of the present disclosure.

Once aerial delivery system 10 reaches recovery parachute release point 2320, processor 221 may issue a control signal configured to cause deployment of one or more recovery parachutes (e.g., recovery parachutes 1710 and 1711) (step: 2140). FIG. 22 is a block diagram of an exemplary deployment sequence 2140 for two or more recovery parachutes (e.g., using release bridle 1900). Upon receiving a signal configured to release one or more recovery parachutes from processor 221, a cutter or other release device (e.g., rip cord extractor) may cause pilot parachute 1750 to deploy from container 1720 (step 2205). Upon deployment of pilot parachute 1750 into an air stream created by the descent and navigation of aerial delivery device 10, pilot parachute 1750 may fill with air and exert a drag force upon drogue parachute 1755, thereby causing extraction of drogue parachute 1755 into the air stream (step 2210).

As shown in FIG. 24, drogue parachute 1755 may be operably connected to recovery parachutes 1710 and 1711 via release bridle 1900. Therefore, as drogue parachute 1755 fills with air in the air stream following deployment, a substantially equal force may be exerted on crowns of recovery parachutes 1711 and 1710 via fixed end 1915 and release end 1916, based on connection of release bridle 1900 to drogue parachute 1755 at drogue end 1910. Such a force may therefore cause extraction of recovery parachutes 1710 and 1711 from recovery containers 1708 and 1709 (step 2220).

During such extraction, the force associated with release bridle 1900 may remain substantially equal at each crown associated with recovery parachutes 1710 and 1711. Thus, the angle θ (FIG. 24) remains substantially the same and the force exerted on retaining pin 1938 may not increase through this extraction phase. However, as the air stream begins to inflate recovery parachutes 1710 and 1711, and they become larger, the angle θ will increase as recovery parachutes 1710 and 1711 separate from one another. As the angle θ increases, the force associated with retaining pin 1938 will gradually increase, until such force is sufficient to remove retaining pin 1938 from cord section 17 (step 2225). Upon such removal of retaining pin 1938, multi-ring release system 1916 may release, thereby allowing recovery parachute 1710 to separate completely from release bridle 1900. Thus, each recovery parachute 1710 and 1711 may continue to fully inflate and decelerate aerial delivery system 10. One of ordinary skill in the art will recognize that release bridle 1900 may include as many release ends 1916 as desired to accommodate any number of recovery parachutes for a given cargo.

Other embodiments of the invention will be apparent to those skilled in the art from consideration of the specification and practice of the invention disclosed herein. For example, upon reaching the ground at target location 2230, processor 221 may recognize that surface winds may be causing recovery parachutes 1710 and 1711 to inflate and “drag” an associated cargo, perhaps away from a ground team. Therefore, processor 221 may issue a control signal configured to cause a disconnection of recovery parachutes 1710 and 1711 from mantle 1800. For example, a cutter (e.g., a pyrotechnic cutter) may be operated, causing a termination of the operable connection between recovery parachute risers and mantle 1800. One of ordinary skill in the art will recognize that other such methods may be implemented.

Further, one of skill in the art will recognize that control box 211 may include wind profile sensing devices allowing determination of wind profiles as aerial delivery system 10 descends through the atmosphere. Therefore, such information may be provided to processor 221 for comparison to ambient data previously loaded to processor 221, and adjustments made based on any determined changes.

It is intended that the specification and examples be considered as exemplary only, with a true scope and spirit of the invention being indicated by the following claims.

What is claimed is:

1. An aerial delivery system, comprising:
a ram-air parachute;
one or more recovery parachutes;
a mantle removably attached to a cargo; and
a controller operably connected to the mantle, the ram-air parachute, and the one or more recovery parachutes, and configured to
receive location information associated with a target;
receive information related to an ambient condition;
determine a recovery parachute opening point based on the target information and the ambient condition; and
cause a navigation of the aerial delivery system to the determined recovery parachute opening point.

2. The aerial delivery system of claim 1, further comprising:
a release bridle, having a first end, a second end, and a third end, the second end fixedly attached to a first one of the one or more recovery parachutes, and the third end releasably attached to a second one of the one or more recovery parachutes;
a drogue parachute affixed to the first end of the release bridle; and
a pilot parachute operably connected to the drogue parachute.

3. The aerial delivery system of claim 2, wherein the releasable attachment of the third end to the second one of the one or more recovery parachutes comprises a multi-ring release system.

4. The aerial delivery system of claim 1, wherein the information related to an ambient condition comprises at least one of an altitude dependent wind velocity.

5. The aerial delivery system of claim 4, wherein the recovery parachute opening point is determined to be at a location upwind of the target location, based on the altitude dependent wind velocity.

6. The aerial delivery system of claim 1, wherein the controller comprises a GPS receiver and a steering servo configured to manipulate a steering line associated with the ram-air parachute for causing the navigation.

7. The aerial delivery system of claim 1, wherein the mantle is configured to support a cargo having a weight ranging from about 1,000 pounds to about 3,000 pounds.

8. The aerial delivery system of claim 1, wherein the mantle is configured to support a cargo having a weight ranging from about 9,000 pounds to about 12,000 pounds.

9. The aerial delivery system of claim 1, further comprising a cutter configured to facilitate removal of the cargo from the mantle based on the ambient condition.

10. The aerial delivery system of claim 1, wherein the location information comprises at least one of a latitude, a longitude, and an altitude.

11. A method for aerially delivering a cargo system from an aircraft at an altitude, the method comprising:
receiving location information associated with a target location;
receiving condition information related to an ambient condition;
determining a recovery parachute opening location based on the condition information and the location information;
deploying a navigable ram-air parachute operably connected to the cargo system;
navigating the cargo system to the recovery parachute opening location via the ram-air parachute and one or more steering lines associated with the ram-air parachute; and
deploying one or more recovery parachutes at the recovery parachute opening location.

12. The method of claim 11, further comprising:
determining an extraction area for deploying the navigable ram-air parachute based on the condition information, and calculating a drop zone at the altitude of the aircraft defined by a base of an inverted cone having an apex at the target location.

13. The method of claim 12, wherein the cone is oblique and is based on a position of the aircraft with respect to the target location.

14. The method of claim 11, wherein determining a recovery parachute opening location comprises:
identifying a wind velocity associated with one or more altitudes from the condition information; and
calculating a flight plan based on the identification.

15. The method of claim 14, wherein the flight plan comprises at least one of a random turn, a sweeping circle, and a centered FIG. 8.

16. The method of claim 15, wherein the navigating further comprises:
manipulating one or more steering lines associated with the navigable ram-air parachute to fly the flight plan.

17. The method of claim 11, wherein deploying one or more recovery parachutes comprises:
extracting a drogue parachute affixed to a first end of a release bridle, wherein a second end of the release bridle is fixedly connected to a first one of the one or more recovery parachutes, and a third end of the release bridle is releasably connected to a second one of the one or more recovery parachutes.

18. The method of claim 17, further comprising:
releasing, when an angle between the second end and the third end reaches a predetermined value, a retaining pin associated with the releasable connection between the third end and the second one of the recovery parachutes, wherein the releasable connection comprises a multi-ring release system.

19. The method of claim 11, wherein the location information comprises at least one of a latitude, a longitude, and an altitude.

20. An aerial delivery system, comprising:
a ram-air parachute;
one or more recovery parachutes;
a mantle removably attached to a cargo;
a release bridle having a first end, a second end, and a third end, the second end fixedly attached to a first one of the one or more recovery parachutes, and the third end releasably attached to a second one of the one or more recovery parachutes;
a drogue parachute affixed to the first end of the release bridle;
a pilot parachute operably connected to the drogue parachute; and
a controller operably connected to the mantle, the ram-air parachute, and the one or more recovery parachutes, and configured to
receive location information associated with a target;
receive information related to an ambient condition;
determine a recovery parachute opening point based on the target information and the ambient condition; and
cause a navigation of the aerial delivery system to the determined recovery parachute opening point.

21. The aerial delivery system of claim 20, wherein the releasable attachment of the third end to the second one of the recovery parachutes comprises a multi-ring release system.

22. The aerial delivery system of claim 20, wherein the ambient condition includes at least one of an altitude dependent wind velocity.

23. The aerial delivery system of claim 22, wherein the recovery parachute opening point is determined to be upwind of the target location, based on the altitude dependent wind velocity.

24. The aerial delivery system of claim 20, wherein the controller comprises a GPS receiver and a steering servo configured to manipulate a steering line associated with the ram-air parachute to cause the navigation.

25. The aerial delivery system of claim 20, wherein the location information comprises at least one of a latitude, a longitude, and an altitude.
